(19) United States
(12) Patent Application Publication
(10) Pub. No.: US 2017/0339840 A1
(43) Pub. Date: Nov. 30, 2017

(54) SUBSTANCE INTRODUCTION METHOD FOR PLANTS

(71) Applicant: HANSON UITGEVERS B.V., Rotterdam (NL)

(72) Inventors: Auguste Antoine VAN DER KAADEN, Moerkapelle (NL); Tomaz JEVSNIK, Dobrovnik (SI)

(73) Assignee: HANSON UITGEVERS B.V., Rotterdam (NL)

(21) Appl. No.: 15/523,898

(22) PCT Filed: Nov. 3, 2015
(86) PCT No.: PCT/NL2015/050768

§ 371 Date: May 2, 2017

(30) Foreign Application Priority Data
Nov. 3, 2014 (NL) 1041031

(51) Int. Cl. A01G 7/06; A01G 9/02

(52) U.S. Cl. CPC A01G 7/06; A01G 9/02

(57) ABSTRACT

A method for introducing a substance into a plant, in particular a pot plant, includes the following steps: forming a hole into a stem of the plant to get access to a transportation system of the plant; filling the hole with a substance absorbing material; and allowing the substance absorbing material to absorb substance and to subsequently deliver the substance from the substance absorbing material to the transportation system of the plant.

### BACKGROUND OF THE INVENTION

The invention relates to a substance introduction method for a plant, in particular a pot plant, e.g. an orchid.

Over the years many different substance introduction methods have been developed to introduce all kinds of substances into a plant, mainly by fluid introduction, which substances may comprise pesticides, fungicides, nutrients, water, flavorants, odorants, colorants and suitable solutions thereof.

An example of a prior art substance introduction method can be found in international patent publication WO93/02546 in which hollow spikes, which are in communication with a reservoir, are pressed into the stem of a plant, such that a transverse passageway of the spikes is located within the xylem system of the plant. Any fluid inside the reservoir is then taken up by the plant using the transpiration pull of the xylem system.

A disadvantage of WO93/02546 is that the system required to perform this method is rather complex. Fabricating and subsequent positioning the spikes with the transverse passageways is not easy.

Another example of a prior art substance introduction method can be found in international patent publication WO87/01559 in which an unpressurized reservoir is connected to the plant via a probe that is able to penetrate the epidermis of the stem of the plant.

A disadvantage of WO87/01559 is that the construction with the reservoir and probes is relatively large compared to the size of the stem of the plant, so that additional mounting aids are required. An additional disadvantage of using probes or needles, e.g. hypodermic needles, that remain connected to the stem during the substance introduction is that there is a significant risk to damage the stem of the plant while handling the probe/needle due to the sharp tip of the probe/needle.

Another example of a prior art substance introduction method can be found in international patent publication WO2012/067496 in which the roots of the plant are physically injured and subsequently the injured roots are brought into contact with a fluid.

A disadvantage of WO2012/067496 is that the plant is severely injured with the chance of the plant dying and that the method is laborious, because of the many steps required, as for instance the plant needs to be taken out of the soil to injure the roots.

A further example of a prior art substance introduction method can be found in European patent publication EP2.308.282 in which a hole is made into the stem of the plant to receive the tip of a pipette, which pipette needs to be fixed to the plant until the fluid is absorbed by the plant.

A disadvantage of EP2.308.282 is that it is not easy to fix the pipette to the plant without leakage.

Yet another example of a prior art substance introduction method can be found in French patent publication FR2.879.073 in which the plant is watered with a substance containing fluid, which is then absorbed by the roots in a natural way.

A disadvantage of FR2.879.073 is that in order for the plant to absorb a certain amount of fluid, a multiple of that amount needs to be introduced into the soil around the plant. Hence, the efficiency is very low compared to methods where the substance containing fluid is administered to the plant in a more direct way.

Another example of a prior art substance introduction method can be found in international patent publication WO2010/085082 in which branches are cut and a storage tube is coupled to the cut branch to introduce fluid into the plant.

A disadvantage of WO2010/085082 is that cutting the branches is not possible or desired for all types of plants, that it is not the most efficient method, that it reduces the value of the plant, and that it requires special measures to make a proper seal between the tube and the cut branch in order to prevent fluid from unintentionally leaking away between the tube and the branch.

A further example of a prior art substance introduction method can be found in US patent publication U.S. Pat. No. 6,405,480 in which a reservoir is formed around the cut stem of a Christmas tree, so that fluid can be forced into the stem to prevent the tree from drying and becoming a fire hazard.

U.S. Pat. No. 6,405,480 assumes that the stem is cut, which is usually the case with a Christmas tree, but is most of the time for all other purposes not desired. Further, the disclosure is complex to implement in practice for a pot plant when the intention is to keep the plant alive for more than a couple of weeks.

Substances may be introduced into plants for different reasons. Pesticides, nutrients, etc. are usually introduced to improve the well-being of the plant, while flavorants, colorants, odorants and the like are introduced to improve the esthetic value perceived by customers buying or using the plants. It is known that some of these substances may be harmful to the plant and that depending on, amongst others, the substance introduction method the life of the plants is shortened or some parts of the plant, such as the flowers or buds, die easily and/or quickly.

### BRIEF SUMMARY OF THE INVENTION

In view of the above it is an object of the invention to provide an improved method for introducing a substance into a plant, in particular a pot plant.

To achieve this object, there is provided a method for introducing a substance into a plant, in particular a pot plant, comprising the following steps:
forming a hole into a stem of the plant to get access to a transportation system of the plant;
filling the hole with a substance absorbing material;
allowing the substance absorbing material to absorb substance and to subsequently deliver the substance from the substance absorbing material to the transportation system of the plant.

The invention is based on the insight of the inventors that the use of a substance absorbing material prevents too much substance to be taken up by the plant at once, which reduces the risk of damage to the plant, e.g. bud failure, while at the same time may allow to introduce a relatively large amount of substance compared to the size of the hole made in the stem.

Another advantage may be that the substance absorbing material applies less destructive loads to the plant than for instance probes, needles or pipettes, because substance absorbing materials are usually made of flexible or resilient material, and/or weigh less.

In an embodiment, the hole formed in the stem is a through hole. This is beneficial when the substance needs to be distributed to multiple parts of the plant, e.g. to all flowers, and thus proper access to the transportation system of the plant is required. Further, a through hole has two entry points for substance with relatively the same amount of destruction of the plant e.g. aiding in an even distribution of the substance through the transportation system.

In an embodiment, the substance absorbing material is provided in the form of a wire to extend through the through hole. The wire will then act as a supply line of substance, so that also substance from outside the hole can be delivered to the hole and thus the hole does not have to act as reservoir.

In an embodiment, the through hole is formed by introducing a tool through the stem of the plant, which tool is preferably a hypodermic needle. The hypodermic needle has the advantage that more damage can be made to plant tissue when making the hole with for instance a sowing needle as a hypodermic needle is able to cut through the plant tissue while a sowing needle may only push plant tissue aside. However, it is explicitly noted that the use of a (sowing) needle to make a hole in the stem of the plant is also falling within the scope of this disclosure.

In an embodiment, the method comprises the following additional steps:
attaching the substance absorbing material to a needle; and
using the needle to introduce the substance absorbing material into the hole such that it extends through the through hole.

The needle allows to easily introduce the substance absorbing material into the hole without having to touch the substance absorbing material. This is especially advantageous when the substance absorbing material has already absorbed substance prior to introducing the substance absorbing material into the hole. This embodiment considers the step of introducing the substance absorbing material into the hole to be separate from the step of forming the hole in the stem of the plant. However, in an alternative embodiment, there is the possibility to attach the substance absorbing material to the tool used to form the hole, introduce the tool into the stem, push and/or pull the tool through the stem to form the hole and let the tool pass the stem thereby automatically introducing the substance absorbing material into the hole. Disconnecting the substance absorbing material from the tool after introducing the substance absorbing material is an option, but depending on the embodiment, it is also possible to keep the tool attached to the substance absorbing material. In that case it is possible that the tool is used again to remove the substance absorbing material later on.

The tool and/or substance absorbing material may be re-used to introduce substance in more than one plant.

It is for instance possible that the tool, e.g. a sowing needle, and substance absorbing material in the form of a wire connected to the tool, is subsequently driven through multiple stems, so that the wire extends from stem to stem. Hence, multiple stems share a single wire. Preferably, the wire is cut in between stems, so that each stem has a separate wire portion used to introduce substance.

In an embodiment, the method further comprises the step of providing a reservoir with substance near the plant, wherein the step of allowing the substance absorbing material to absorb substance comprises making contact between the substance absorbing material and the substance in the reservoir. In that case, the substance may be drawn from outside the hole to into the hole via the substance absorbing material, which makes the supply of substance easier with less risk of leakage.

The reservoir may be attached to the stem of the plant below the hole, so that the substance absorbing material can easily be hung in the reservoir for making contact with the substance in the reservoir. In a preferred embodiment, the distance from the substance in the reservoir to the hole is minimized as much as possible. This may include filling the reservoir with substance as much as possible.

In an embodiment, the step of allowing the substance absorbing material to absorb substance comprises wetting the substance absorbing material with substance and/or water prior to being introduced into the hole. This will make initial transport and delivery of substance by the substance absorbing material easier and introducing substance to the plant can be carried out faster.

After the substance has been introduced into the plant, the hole is preferably closed to keep the plant in good health.

Closing may be done while leaving the substance absorbing material in the hole, so that the hole remains filled and the substance absorbing material can be used as part of the transportation system of the plant.

Alternatively, before closing the hole, the substance absorbing material may be removed from the hole. This is especially beneficial when the substance absorbing material extends outside the hole and this is not easy to leave behind in the hole.

The step of closing the hole may comprise providing the interior wall of the hole with a layer of material preventing said wall from drying, i.e. applying a layer of material to the interior wall. This layer of material may for instance be sprayed into the hole or by exposing the interior of the hole to a solution such that a layer of material is deposited on the interior wall of the hole.

The hole in the stem may be closed using wax, preferably bee wax, and/or the interior wall may be provided with a layer of wax, preferably also bee wax. Providing a layer of material on the interior wall of the hole and closing the hole may be done in a single operation by completely filling the hole with material, e.g. the bee wax.

In an embodiment, closing the hole is carried out by providing a cover over the hole, wherein a seal is provided between the cover and the stem of the plant. This can for instance be done by covering the hole with a tape, preferably flexible or resilient tape to provide the seal. After covering the hole with the cover, clamping means such as a clip may be provided over the cover to keep the cover in place.

In an embodiment, a size of the substance absorbing material is larger than a size of the hole in the stem. For instance, the diameter of the wire of substance absorbing material is larger than the diameter of the through hole in the stem of the plant. In this way, there is good contact between substance absorbing material and interior of the hole.

In an embodiment, the substance absorbing material comprises cotton.

The substances introduced may include:
pesticides;
fungicides;
nutrients;
flavorants;
colorants;
odorants;
   and any mixtures or suitable solutions thereof.

The substance may alternatively be referred to as matter, component, ingredient, element, constituent, material and essence, and for instance also as compound, mixture, blend or composition when the substance contains multiple ingredients.

A hole in this specification is broadly defined and includes any cavity, cut or passageway extending from an opening in an outer surface of the stem into the interior of the stem allowing the interior of the stem to be exposed to a substance absorbing material entering the plant via the opening. As an example, making a longitudinal cut in the stem of the plant falls within the definition when this results in an opening in the outer surface of the stem through which a substance absorbing material can enter the interior of the stem of the plant. Hence, in case a cut is made with a very thin blade resulting in injuring the stem of the plant, but in which the opposing walls of the cut are sealed together, so that no substance absorbing material can enter the interior of the stem of the plant, this is not a hole as defined in this specification.

In an embodiment, the hole is formed on the lower half of the stem of the plant, preferably below the part for which the substance is intended to be delivered.

In an embodiment, the plant is not a woody stemmed type plant, but comprises soft stem tissue with hard outer wall (e.g. cuticle) or epidermis (e.g. as in herbaceous plants). The plant is preferably a plant that at least in its youth stage has stems that are not lignified. The plant is preferably a herbaceous plant with soft stem tissue.

In an embodiment, the plant is a vascular plant, preferably a plant in the orchid family (orchidaceae) and more preferably the plant is a Phalaenopsis orchid or a Denbromium orchid.

In an embodiment, when taking up the substance quick is a desire or requirement, it is advantageous not to water the plant before the substance introduction, i.e. the plant needs watering before substance introduction, so that the plant is ‘thirsty’ and will quickly take up the substance.

When the substance to be introduced into the plant is introduced as a solution, e.g. by dissolving a powder into water, the concentration of the solute may be changed depending on the application. In an embodiment, in which the substance absorbing material is introduced into the hole and the hole is subsequently closed, the concentration may be relatively high, as all the solute to be taken up by the plant needs to be introduced into the hole with the substance absorbing material. When a reservoir is used, so that substance delivered by the substance absorbing material to the plant is replenished from the reservoir, the concentration may be relatively low.

The substance absorbing material may be any material in which capillary forces allow the transport of substance through the substance absorbing material.

### BRIEF DESCRIPTION OF THE DRAWINGS

The invention will now be described in a non-limiting way with reference to the accompanying drawings in which like parts are indicated by like reference symbols and in which:

FIG. 1 depicts schematically a plant, in particular a pot plant;

FIG. 2 depicts a cross-section of a stem of a plant in which a hole is filled with a substance absorbing material; and

FIGS. 3-6 depict steps in a method according to an embodiment of the invention.

### DETAILED DESCRIPTION OF THE INVENTION

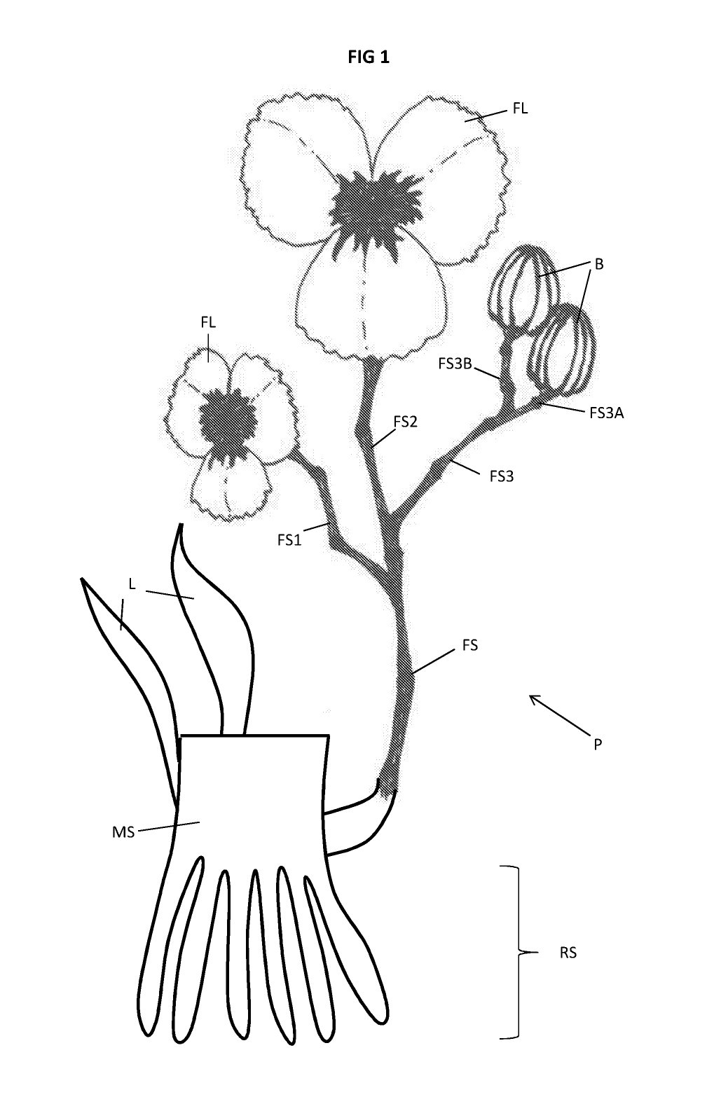

FIG. 1 depicts a schematic drawing of a plant P, in particular a pot plant. FIG. 1 shows schematically the different parts of a plant. The shown parts of a plant are the root system RS, the stem structure including the stems MS, FS, FS1, FS2, FS3, FS3A, FS3B of the plant, the leaves L of the plant, the flowers FL of the plant and the buds B of the plant P.

The root system RS of the plant is the non-leaf, non-nodes bearing part of the plant P. The major functions of the root system RS may be one or more of the following:
1) absorption of water and inorganic nutrients;
2) anchoring of the plant body to the ground or any other base structure and supporting it;
3) storage of food and nutrients;
4) vegetative reproduction.

The root system RS forms one end of the plant P, the flowers FL, leaves L and buds B form the other end of the plant P. In the schematic drawing of FIG. 1 a non-fruit bearing plant is shown, but it will be apparent that a plant P may also comprise fruits as it comprises leaves L, flowers FL and buds B.

The stem structure connects the flowers FL, leaves L and buds B to the root system RS and has one or more of the following functions:
1) support for and the elevation of leaves L, flowers FL and/or fruits;
2) transport of fluids between roots and the leaves L, flowers FL and/or fruits;
3) storage of nutrients; and
4) production of new living tissue.

In the shown example, the plant P comprises a main stem MS which acts as the main support for all other plant parts except the root system RS and through which all fluids passes. In this example, the main stem MS supports the leaves L and other stems, in this case flower stem FS. The flower stem FS in turn is split up into three flower sub-stems FS1, FS2, FS3. Flower sub-stems FS1 and FS2 each carry one flower FL. Flower sub-stem FS3 is split into sub-stems FS3A and FS3B each carrying a bud B, which will later on develop into a flower FL as well. It will be apparent to the skilled person that the shown structure of the stems is a mere example and that the plant may also have a different configuration.

The method described in this specification may be applied to all kind of stems of the stem structure. However, in practice, the user will choose a specific stem for carrying out the method depending on the purpose, i.e. the intended destination, of the substances to be introduced into the plant.

When for instance the substance is intended for only the leaves L of the plant P of FIG. 1 or for all leaves L, flowers FL and buds B, the method will preferably be carried out in relation to the main stem MS, as introducing the substance into the main stem MS will result in the substance being distributed to all parts of the plant P carried by the main stem MS.

When for instance the substance is not intended for the leaves L but for the flowers FL and buds B, the method is preferably carried out in relation to the flower stem FS. Likewise, if the substance is only intended for the buds B and not for any other part of the plant, the method is preferably carried out in relation to the flower sub-stem FS3. As the methods can be applied to all kind of stems, only the general term stem is and will be used throughout the remaining detailed description of the invention.

It will be apparent to the skilled person that alternative to choosing a single specific stem, it is also possible to carry out the method in relation to multiple stems of a plant P, possibly simultaneously. For instance, if a substance is intended for the flowers FL and buds B, the method may be carried out in relation to flower stem FS as described above, but alternatively, the method may also be carried out in relation to flower sub-stems FS1, FS2 and FS3.

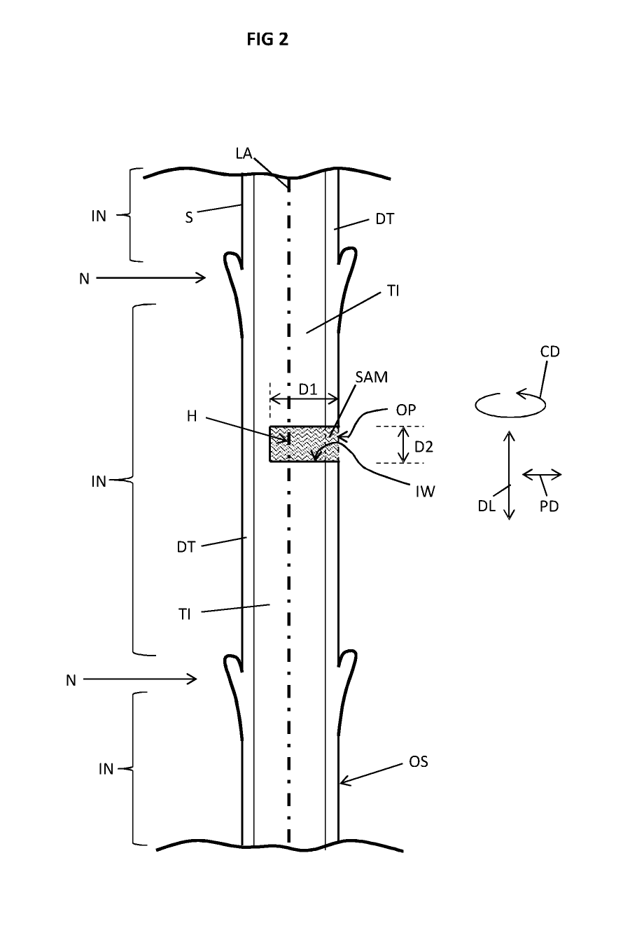

FIG. 2 depicts a cross-section of a stem S of a plant, e.g. a plant according to FIG. 1. The stem Sofa plant is usually divided into nodes N and internodes IN in between nodes N. The nodes N may hold buds (not shown here) which grow into one or more leaves, sub-stems or flowers as shown in FIG. 1.

The stem S comprises dermal tissue DT, which may alternatively be referred to as epidermis, defining an outer surface OS of the stem S and usually functions to waterproof, protect and control gas exchange. Plant tissue TI below the dermal tissue comprises vascular tissue and ground tissue filling in around the vascular tissue. The vascular tissue provides long distance transport in the form of xylem and phloem, alternatively referred to as xylem system and phloem system of a plant. The substance introduction methods described in this specification rely amongst others on the xylem and/or phloem transport systems in order to distribute the introduced substance throughout the plant, where the xylem is preferred as it has a single known transport direction where the phloem may be multi-directional. Hence, the distribution of the substance throughout the plant via the xylem system is more predictable.

The stem S defines a longitudinal axis LA. This allows to define and describe some directions in relation to the longitudinal axis LA. A first direction DL is oriented parallel to the longitudinal axis LA of the stem, a second direction PD is oriented perpendicular to the longitudinal axis LA of the stem, and a third direction is a circumferential direction CD around the longitudinal axis LA of the stem.

FIG. 2 depicts a hole H which extends from an opening OP in the outer surface OS of the stem S in the second direction PD into the tissue TI, so beyond the dermal tissue DT in order to get access to the long distance transportation system, preferably the xylem. The depth of the hole H in this example is larger than the radius of the stem at this location, and is in this case also larger than the diameter D2 of the hole H.

The hole H comprises an interior wall IW delimiting the hole from the tissue in the stem of the plant. When a substance is introduced into the hole, the substance needs to penetrate the plant by passing the interior wall IW in order to be taken up by the plant, e.g. by the transportation system of the plant.

The hole H may be formed by drilling or cutting, but in an embodiment is formed by inserting a hypodermic needle with a beveled tip into the stem. The beveled tip has the advantage that the needle has a sharp tip able to penetrate the dermal tissue and that the entire beveled portion of the tip forms a cutting surface which can be used to form the hole by subsequent rotation of the needle about its longitudinal axis, preferably after it has been brought to the desired depth D1. Rotating the needle will then cut through the tissue and allow for easy removal of the plant tissue.

When the hypodermic needle is manually inserted into the stem of the plant, it can be advantageous to use a hypodermic needle, wherein the length of the beveled tip is substantially the same as the desired hole depth D1. In that case, the hypodermic needle can be inserted into the stem until the first moment the beveled tip is completely inserted into the stem. This will aid in preventing the hypodermic needle from being inserted too deep and extending through the plant on the opposite side of the opening OP. In that way, it is ensured that a blind hole as in FIG. 2 is formed. However, it is also possible to make a through hole as will be described later on. In that case, no precautions preventing a tool from extending through the stem need to be taken.

The hole H is filled with a substance absorbing material SAM. The substance absorbing material SAM has absorbed substance prior to being inserted into the hole H. After being inserted into the hole H, the substance absorbing material SAM delivers substance to the transportation system of the plant. The advantage of the substance absorbing material is that it can easily carry the substance and may allow to set the maximum delivery rate of substance.

Not shown in FIG. 2 is that the hole H may be covered by a cover, e.g. a flexible tape closing the hole by sealingly engaging with the stem of the plant surrounding the hole H. The cover keeps the substance absorbing material inside the hole H, and thus prevents the substance absorbing material from falling out of the hole. It further protects the interior of the hole. Further, it may prevent dehydration of the plant via the hole. The cover and substance absorbing material may stay on and in the plant, even when no substance is left in the substance absorbing material. In that case the substance absorbing material may become part of the transportation system of the plant and the cover keeps the ‘wound’ in the stem of the plant closed. However, it is also possible to remove the substance absorbing material and subsequently close the hole again.

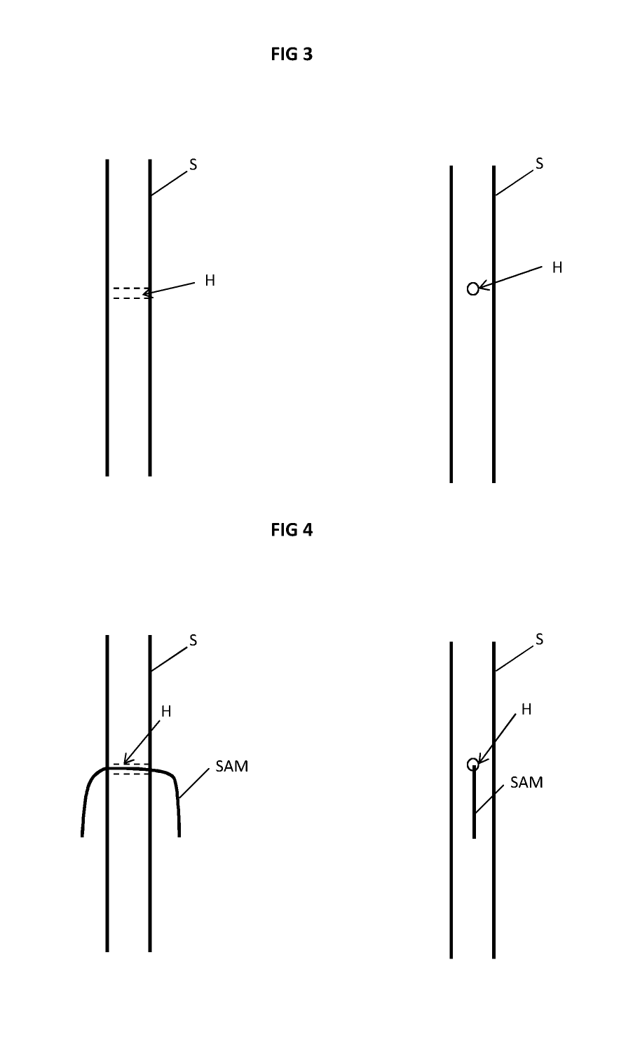

FIGS. 3-6 depict subsequent steps in a method according to an embodiment of the invention. Each of these figures show a stem S of a plant in front view on the left and in side view on the right.

FIG. 3 depicts the stem S of a plant in which a through hole H has been formed by introducing a tool, e.g. a hypodermic needle into the stem of the plant. In this way, access to the transportation system of the plant is obtained.

The location of the hole H depends on the purpose of the substance introduction, but is preferably below the parts that need the substance such that the fluid flow in the transportation system of the plant first passes the hole H and then continues to the parts requiring the substance.

Techniques to form the hole in the stem of the plant may comprise one or more of the following operations: drilling, cutting, suction, vaporizing, lasering, chemical etching and piercing.

FIG. 4 depicts a subsequent step in which a thread of substance absorbing material SAM, alternatively referred to as wire, is inserted into the hole H to extend through the through hole H. In this embodiment, the wire SAM is positioned such that the ends on both side of the hole have a substantially equal length.

It may be preferred to wet the substance absorbing material SAM with substance and/or water prior to being inserted, so that delivery of the substance to the plant can start immediately after inserting.

The wire SAM may be inserted into the hole H using a needle, e.g. by attaching the wire to the needle and letting the needle pass through the hole H.

FIG. 5 depicts a subsequent step in which a reservoir R is attached to the stem S of the plant below the hole H, filled with substance SU and in which both ends of the substance absorbing material SAM are introduced into the reservoir R, so that the plant is able to take in the substance SU from the reservoir using the substance absorbing material SAM.

Preferably, the distance from the substance SU to the hole H is as short as possible. Hence, the reservoir is attached to the stem as high as possible and the reservoir is filled as much as possible, so that the initial level of substance SU is as high as possible and thus as close as possible to the hole H.

The situation of FIG. 5 may last as long as is necessary, for instance 12-24 hours.

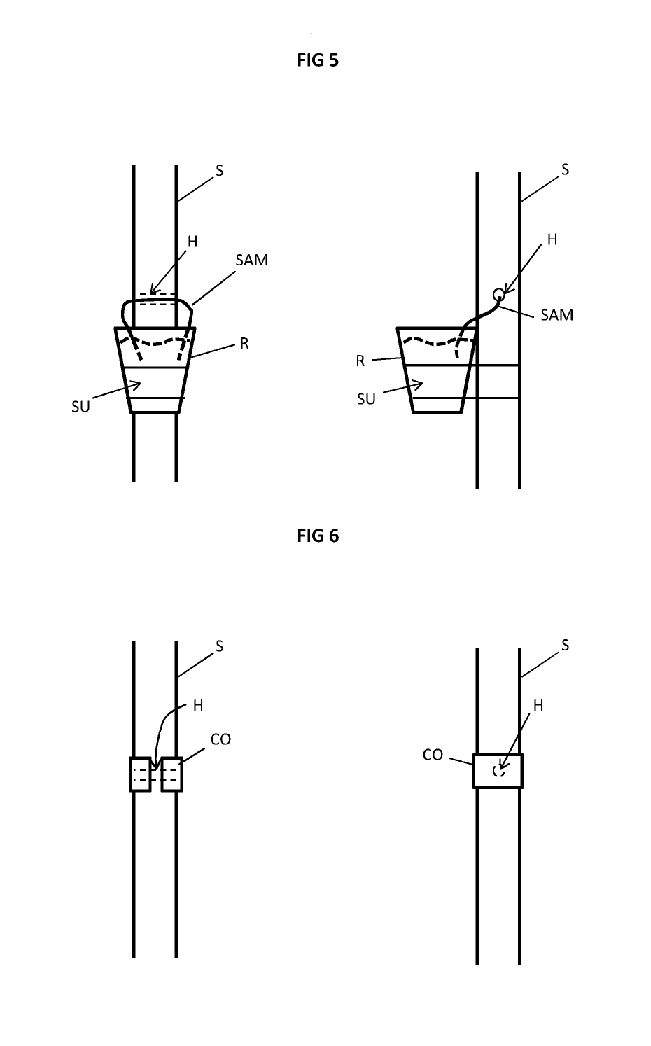

After sufficient substance has been introduced into the plant, the reservoir R and substance absorbing material may be removed from the stem S and hole H. The hole H may be covered by a cover CO as shown in FIG. 6. This cover CO may be provided in the form of a tape.

1. A method for introducing a substance into a plant, comprising the following steps:
forming a hole into a stem of the plant to get access to a transportation system of the plant;
filling the hole with a substance absorbing material; and
allowing the substance absorbing material to absorb substance and to subsequently deliver the substance from the substance absorbing material to the transportation system of the plant.

2. The method according to claim 1, wherein the hole formed in the stem is a through hole.

3. The method according to claim 2, wherein the substance absorbing material is provided in the form of a wire to extend through the through hole.

4. The method according to claim 2, wherein the through hole is formed by introducing a tool through the stem of the plant.

5. The method according to claim 4, wherein the tool is a hypodermic needle.

6. The method according to claim 2, further comprising the steps of:
attaching the substance absorbing material to a needle; and
using the needle to introduce the substance absorbing material into the hole such that the substance absorbing material extends through the through hole.

7. The method according to claim 3, further comprising the step of providing a reservoir with substance near the plant, wherein the step of allowing the substance absorbing material to absorb substance comprises making contact between the substance absorbing material and the substance in the reservoir.

8. The method according to claim 7, wherein providing the reservoir with substance near the plant comprises attaching the reservoir to the stem of the plant below the hole.

9. The method according to claim 1, wherein the step of allowing the substance absorbing material to absorb substance comprises wetting the substance absorbing material with substance and/or water prior to being introduced into the hole.

10. The method according to claim 1, further comprising the step of closing the hole while the substance absorbing material remains in the hole.

11. The method according to claim 1, further comprising the steps of removing the substance absorbing material from the hole and subsequently closing the hole.

12. The method according to claim 10, wherein closing the hole comprises the step of applying a layer of material to an interior wall of the hole preventing said wall from drying.

13. The method according to claim 10, wherein closing the hole is carried out using wax.

14. The method according to claim 10, wherein closing the hole is carried out by providing a cover over the hole, wherein a seal is provided between the cover and the stem of the plant.

15. The method according to claim 3, wherein a diameter of the substance absorbing material is larger than a diameter of the through hole.

16. The method according to claim 1, wherein the substance absorbing material comprises cotton.

17. The method according to claim 13, wherein the wax is bee wax.

18. The method according to claim 3, further comprising the steps of:
attaching the substance absorbing material to a needle; and
using the needle to introduce the substance absorbing material into the hole such that the substance absorbing material extends through the through hole.

19. The method according to claim 11, wherein closing the hole comprises the step of applying a layer of material to an interior wall of the hole preventing said wall from drying.

20. The method according to claim 11, wherein closing the hole is carried out using wax.
